(19) United States
(12) Patent Application Publication
(10) Pub. No.: US 2019/0259341 A1
(43) Pub. Date: Aug. 22, 2019

(54) ELECTRONIC DEVICE FOR CALCULATING DETERIORATION OF PIXEL

(71) Applicant: SAMSUNG ELECTRONICS CO., LTD., Suwon-si (KR)

(72) Inventors: Hyunjun PARK, Suwon-si (KR); Dongkyoon HAN, Suwon-si (KR); Hanyuool KIM, Suwon-si (KR); Seungkyu CHOI, Suwon-si (KR)

(21) Appl. No.: 16/281,514

(22) Filed: Feb. 21, 2019

(30) Foreign Application Priority Data
Feb. 21, 2018 (KR) 10-2018-0020286

(51) Int. Cl. G09G 3/3283; G09G 3/3233

(52) U.S. Cl. CPC G09G 3/3283; G09G 3/3233; G09G 2320/0285; G09G 2320/0233; G09G 2330/021

(57) ABSTRACT

An electronic device according to an embodiment of the present disclosure includes a display including at least one pixel, a memory configured to store a first current value flowing through the pixel at a first time point, a power management integrated circuit (PMIC) configured to supply pixel power to the pixel, and a processor operatively connected to the memory and the PMIC.

### CROSS-REFERENCE TO RELATED APPLICATION

This application is based on and claims priority under 35 U.S.C. § 119 to Korean Patent Application No. 10-2018-0020286, filed on Feb. 21, 2018, in the Korean Intellectual Property Office, the disclosure of which is incorporated by reference herein its entirety.

### BACKGROUND

### 1. Field

The present disclosure relates to a technology for calculating an amount of deterioration of a display.

### 2. Description of Related Art

A display may display various kinds of images, pictures, and the like by allowing pixels included therein to emit light. For example, one pixel may include a red subpixel, a green subpixel, and a blue subpixel. The display may display various kinds of images, pictures, and the like by allowing each of the subpixels to emit light.

Meanwhile, since the red subpixel, the green subpixel, and the blue subpixel have different structures, the loads applied to subpixels, respectively may be different from each other. For example, the blue subpixel may have a larger aperture ratio than other subpixels, and thus, the load applied to the blue subpixel may be greater than those of the other subpixels. Due to the load difference, the subpixels may be deteriorated at mutually different rates, thereby causing image sticking.

To prevent and/or reduce image sticking in advance, various electronic devices (e.g., a smart phone) including displays may calculate an amount of deterioration of a display (or a pixel). For example, based on the time when a user uses the electronic device, the brightness information of the display, and the like, the electronic device may calculate the amount of deterioration of the display. However, since the scheme of measuring an amount of deterioration described above may be varied depending on the configuration of the electronic device, the operating environment of the electronic device, and the like, the actual amount of deterioration occurring in the display cannot be accurately calculated.

The above information is presented as background information only to assist with an understanding of the present disclosure. No determination has been made, and no assertion is made, as to whether any of the above might be applicable as prior art with regard to the present disclosure.

### SUMMARY

Embodiments of the present disclosure address at least the above-mentioned problems and/or disadvantages and provide at least the advantages described below. Accordingly, an aspect of the present disclosure is to provide an electronic device.

In accordance with an aspect of the present disclosure, an electronic device may include a display including at least one pixel, a memory configured to store a first current value flowing through the pixel at a first time point, a power management integrated circuit (PMIC) configured to supply pixel power to the pixel, and a processor operatively connected to the memory and the PMIC, wherein the processor may be configured to control the electronic device to supply the pixel power to the pixel through the PMIC in response to a user input for calculating an amount of deterioration of the pixel, to receive a second current value flowing through the pixel at a second time point from the PMIC, and to calculate the amount of deterioration of the pixel based on the first current value and the second current value.

In accordance with another aspect of the present disclosure, an electronic device may include a display including at least one pixel, a power management integrated circuit connected to the pixel, a memory configured to store an initial current value flowing through the pixel, and a processor operatively connected to the power management integrated circuit and the memory, wherein the processor may be configured to control the electronic device to supply a current to the pixel through the power management integrated circuit in response to a user input for calculating an amount of deterioration of the pixel, and to calculate the amount of deterioration of the pixel based on a difference between a current value flowing the pixel and the initial current value.

In accordance with still another aspect of the present disclosure, a method of calculating an amount of deterioration may include supplying pixel power to a pixel via a power management integrated circuit in response to a user input for calculating an amount of deterioration of the pixel, measuring a current value flowing through the pixel via the power management integrated circuit when a current flows through the pixel, receiving the measured current value from the power management integrated circuit, and calculating the amount of deterioration of the pixel based on a difference between the measured current value and a current value stored in a memory.

In accordance with still another aspect of the present disclosure, an electronic device may include a display including one or more pixels, a power supply circuit configured to supply power to the one or more pixels, a memory configured to store a first current value supplied to at least some pixels of the one or more pixels through the power supply circuit, and a processor, wherein the processor may be configured to control the display to display specified contents, to control the electronic device to measure a second current value supplied to the at least some pixels through the power supply circuit while the specified contents are displayed, and to determine a level associated with deterioration of the at least some pixels based on at least a difference between the first current value and the second current value.

In accordance with another aspect of the present disclosure, an electronic device may include a display including one or more pixels, a power supply circuit configured to supply power to the one or more pixels, and a processor, wherein the processor may be configured to control the display to display specified contents, to control the electronic device to measure a first current value supplied to at least some pixels through the power supply circuit while the specified contents are displayed, and to determine a level associated with deterioration of the at least some pixels based at least on a difference between the first current value and a second current value measured through the power supply circuit before measuring the first current value.

According to the embodiments of the present disclosure, the amount of deterioration of a display may be accurately measured.

In addition, various effects that are directly or indirectly understood through the present disclosure may be provided.

Other aspects, advantages, and salient features of the disclosure will become apparent to those skilled in the art from the following detailed description, which, taken in conjunction with the annexed drawings, discloses various embodiments of the present disclosure.

### BRIEF DESCRIPTION OF THE DRAWINGS

The above and other aspects, features, and advantages of certain embodiments of the present disclosure will be more apparent from the following detailed description, taken in conjunction with the accompanying drawings, in which:

FIG. 1 is a diagram illustrating an example electronic device according to an embodiment;

FIG. 2 is a block diagram illustrating an example hardware configuration included in an electronic device according to an embodiment;

FIG. 3 is a circuit diagram illustrating an example subpixel according to an embodiment;

FIG. 4A is a flowchart illustrating an example method of operating an electronic device according to an embodiment;

FIG. 4B is a flowchart illustrating an example method of operating an electronic device according to another embodiment;

FIG. 5 is a diagram illustrating an example electronic device for calculating the amount of deterioration occurring in a partial area of a display according to an embodiment;

FIG. 6A is a diagram illustrating an example display divided into several areas according to an embodiment;

FIG. 6B is a diagram illustrating an example state in which an electronic device according to an embodiment adjusts a deterioration amount calculation range;

FIG. 7A is a diagram illustrating example current values flowing through red subpixels according to an embodiment;

FIG. 7B is a diagram illustrating example current values flowing through green subpixels according to an embodiment;

FIG. 7C is a diagram illustrating example current values flowing through blue subpixels according to an embodiment;

FIG. 8 is a block diagram illustrating an electronic device in a network environment according to various embodiments; and

FIG. 9 is a block diagram illustrating an example display device according to various embodiments.

### DETAILED DESCRIPTION

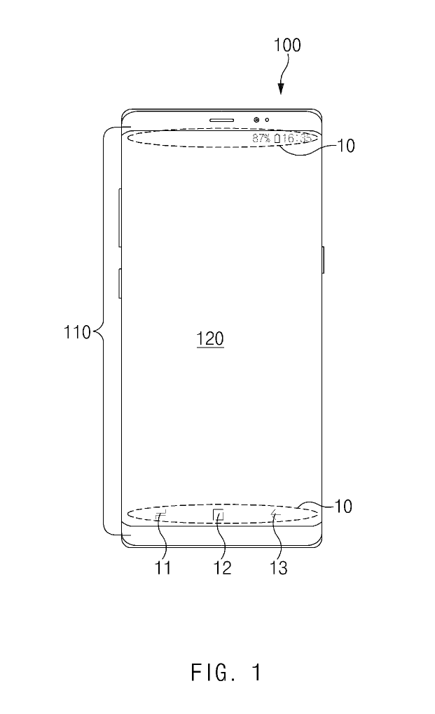

FIG. 1 is a diagram illustrating an example electronic device according to an embodiment.

Referring to FIG. 1, an electronic device 100 may include a housing 110 and a display 120.

The housing 110 may protect various components included in the electronic device 100 from external impacts. For example, the housing 110 may protect the display 120, a printed circuit board, and the like, which are arranged inside the electronic device 100, from external impacts.

The display 120 may be arranged (disposed) within the housing 110. The display 120 may receive a user input (e.g., a touch, a gesture, hovering, and the like) and/or display various contents (e.g., text, images, video, icons, widgets, symbols, and the like).

According to an embodiment, the electronic device 100 may calculate an amount of deterioration of the display 120 to prevent, compensate for and/or reduce image sticking 10 that may be generated on the display 120 in advance. For example, when a user uses the electronic device 100 for a long time, as shown in FIG. 1, the image sticking 10 may be generated on the display 120. For example, as a home key 12, a back key 13, a menu key 11, and the like are images always displayed to a home screen, the image sticking 10 of shapes of the home key 12, the back key 13, and the menu key 11 may be generated on the display 120. According to an embodiment of the present disclosure, since the electronic device 100 may accurately measure the amount of deterioration occurring in the display 120, the user may prevent, reduce and/or compensate for the deterioration of the display 120 before the image sticking 10 is generated. For example, the user may adjust the brightness of the display 120 before the image sticking 10 is generated.

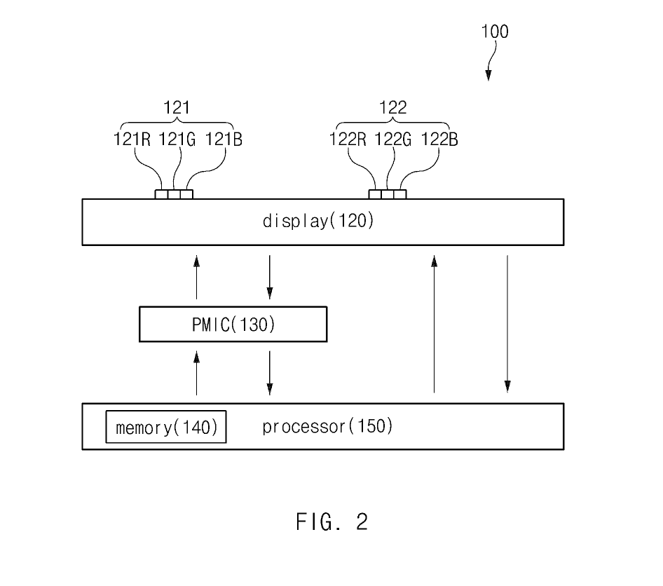

FIG. 2 is a block diagram illustrating an example hardware configuration included in an electronic device according to an embodiment.

Referring to FIG. 2, the electronic device 100 may include the display 120, a power management integrated circuit (e.g., a power supply circuit) 130, a memory 140, and a processor (e.g., including processing circuitry) 150. In the present disclosure, the power management integrated circuit 130 may be referred to as a power supply circuit.

The display 120 may include a plurality of pixels 121 and 122. The display 120 may allow at least some of the plurality of pixels 121 and 122 to emit light, thereby displaying various contents.

Each of the pixels 121 and 122 may include a plurality of subpixels 121R, 121G, 121B, 122R, 122G and 122B. For example, each of the pixels 121 and 122 may include a red subpixel 121R, 122R, a green subpixel 121G, 122G, and a blue subpixel 121B, 122B. The configuration of the pixels 121 and 122 shown in FIG. 2 is only an example, and embodiments of the present disclosure may be different from that shown in FIG. 2. For example, each of the pixels 121 and 122 may include a red subpixel, a green subpixel, a blue subpixel, and a green subpixel.

The power management integrated circuit 130 may supply pixel power to each of the subpixels 121R, 121G, 121B, 122R, 122G, and 122B. For example, the power management integrated circuit 130 may apply a first voltage (e.g., ELVDD) to one end of each of the subpixels 121R, 121G, 121B, 122R, 122G, and 122B, and may apply a second voltage (e.g., ELVSS) to opposite ends of the subpixels 121R, 121G, 121B, 122R, 122G, and 122B. The subpixel supplied with the pixel power may emit light.

The memory 140 may store a first current value flowing through each of the subpixels 121R, 121G, 121B, 122R, 122G, and 122B at a first time point. The first time point may refer, for example, to a time point at which the electronic device 100 is operated for the first time after being processed. The first current value may refer, for example, to an initial current value flowing through the subpixels 121R, 121G, 121B, 122R, 122G, and 122B. For example, the first current value may refer to a current value flowing through the subpixels 121R, 121G, 121B, 122R, 122G, and 122B when the electronic device 100 is operated for the first time after being processed. The first current value may be stored in the memory 140 during the process of the electronic device 100 and may be measured by the power management integrated circuit 130 when the electronic device 100 is operated for the first time.

According to an embodiment of the present disclosure, the power management integrated circuit 130 may store, in the memory 140, the power supplied to at least some pixels of at least one pixel. For example, information about the first current value may be stored in the memory 140 when some pixels are powered corresponding to the first current value.

Although the memory 140 shown in FIG. 2 is shown as being included in the processor 150, the disclosure is not limited thereto, and the memory 140 may be a separate hardware configuration that is not included in the processor 150. In the present disclosure, the memory 140 may, for example, be referred to as a nonvolatile memory (NVM).

The processor 150 may include various processing circuitry and calculate the amount of deterioration of the display 120 (or, pixels and subpixels). The processor 150 may allow the power management integrated circuit 130 to supply pixel power to each of the subpixels 121R, 121G, 121B, 122R, 122G and 122B in response to a user input for calculating the amount of deterioration of the display 120. In the present disclosure, the user input may, for example, be referred to as the execution of an application capable of calculating the amount of deterioration of the display 120, a touch of the display 120, a combination of parts capable of calculating the amount of deterioration of the display 120, or the like, but is not limited thereto.

When the pixel power is supplied to the subpixels 121R, 121G, 121B, 122R, 122G, and 122B, each of the subpixels 121R, 121G, 121B, 122R, 122G, and 122B may emit light. In this case, the processor 150 may allow the power management integrated circuit 130 to measure the second current value flowing through the subpixels 121R, 121G, 121B, 122R, 122G, and 122B at the second time point. The second time point, which may, for example, be a time point after the electronic device 100 is operated for the first time, may refer to a time point at which the user input is received. The second current value may refer, for example, to a current value flowing through the subpixels 121R, 121G, 121B, 122R, 122G, and 122B at the second time point.

According to an embodiment of the present disclosure, while the electronic device 100 displays contents, the second current value supplied to the at least some pixels may be measured. The second current value may refer, for example, to a current value measured while contents are displayed.

When the second current value is measured, the processor 150 may receive the second current value from the power management integrated circuit 130. The processor 150 may subtract the second current value from the first current value and calculate the amount of deterioration of each of the subpixels 121R, 121G, 121B, 122R, 122G and 122B based on the subtraction result (e.g., a difference between the first and second current values). For example, the processor 150 may determine that the amount of deterioration of each of the subpixels 121R, 121G, 121B, 122R, 122G, and 122B is larger as the difference between the first and second current values is larger, and that the amount of deterioration of each of the subpixels 121G, 121B, 122R, 122G, and 122B is smaller as the difference between the first and second current values is smaller. According to an embodiment, the amount of deterioration may be calculated as, for example, and without limitation, a magnitude of current (mA), a brightness (nit) of a pixel, a grayscale, and the like.

A scheme of measuring an amount of deterioration according to a comparative example may vary depending, for example, on the configuration of the electronic device, the operating environment of the electronic device, and the like, so that the actually generated deterioration amount may not be accurately calculated. However, according to an embodiment of the present disclosure, the amount of deterioration generated in the display 120 may be accurately measured by calculating the amount of deterioration based on the current value flowing through a pixel. In the present disclosure, the details described with reference to FIGS. 1 and 2 may be equally applied to configurations having the same reference numerals as those of the electronic device 100 shown in FIGS. 1 and 2.

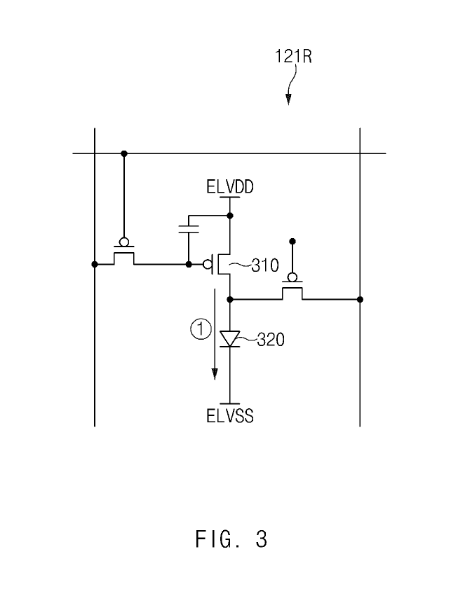

FIG. 3 is a circuit diagram illustrating a subpixel according to an embodiment. FIG. 3 is an enlarged view of the red subpixel 121R shown in FIG. 2.

Referring to FIG. 3, the subpixel 121R may include a driving transistor 310 and an organic light emitting diode 320. One end of the driving transistor 310 may be connected to the power management integrated circuit 130 and an opposite end of the driving transistor 310 may be connected to the organic light emitting diode 320. One end of the organic light emitting diode 320 may be connected to the driving transistor 310 and an opposite end of the organic light emitting diode 320 may be connected to the power management integrated circuit 130.

According to an embodiment, the power management integrated circuit 130 may apply the first voltage (e.g., ELVDD) to one end of the driving transistor 310. In addition, the power management integrated circuit 130 may apply the second voltage (e.g., ELVSS) to the opposite end of the organic light emitting diode 320. When the first and second voltages are applied to the driving transistor 310 and the organic light emitting diode 320, respectively, a current may flow through the organic light emitting diode 320 along a first path \textcircled{1}. The power management integrated circuit 130 may measure the magnitude (or the current value) of current flowing along the first path \textcircled{1}, and may transmit the measured current value to the processor 150.

According to an embodiment, the first and second current values described in FIG. 2 may refer, for example, to the magnitudes of the currents flowing along the first path \textcircled{1}. However, the time points at which the first and second current values are measured may be different from each other, where the first current value may refer, for example, to a current value measured when the display 120 is initially driven and the second current value may refer, for example, to a current value measured at the time point when the user input is received after the display 120 is initially driven.

According to an embodiment of the present disclosure, the amount of deterioration caused in the display 120 may be accurately calculated by calculating the amount of deterioration based on the current value flowing through the pixel (or the subpixel). In the present disclosure, the description of the subpixel 121R may also be applied to other subpixels 121G, 121B, 122R, 122G, and 122B.

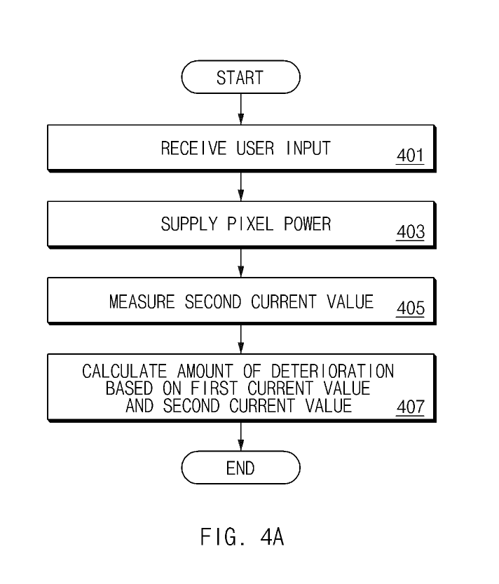

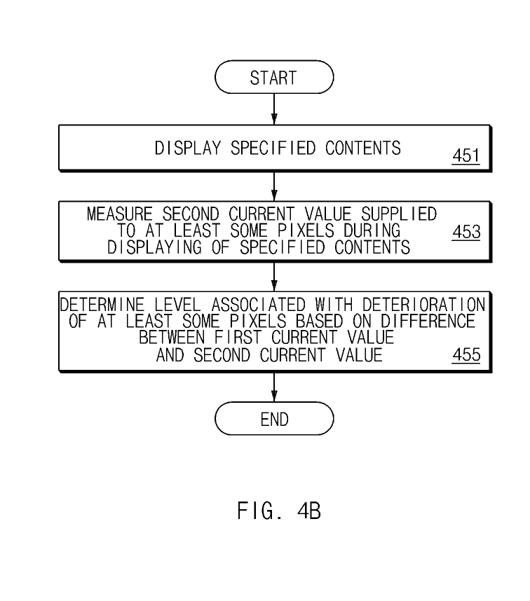

FIG. 4A is a flowchart illustrating an example method of operation of an electronic device according to an embodiment.

Referring to FIG. 4A, in operation 401, the processor 150 may receive a user input. For example, and without limitation, when a user executes an app capable of calculating the amount of deterioration of the display 120, couples a component capable of calculating the amount of deterioration of the display 120 to the electronic device 100, or the like, the processor 150 may recognize it as a user input.

According to another embodiment, operation 401 may be omitted. For example, the electronic device 100 may measure a second current value at a specific time or by specified periods based on a setting of a user or a manufacturer. In this case, the processor 150 may control the power management integrated circuit 130 to supply power to the pixel at the specific time or by the specific periods.

In operation 403, the processor 150 may control the power management integrated circuit 130 to supply pixel power to the pixel. For example, the processor 150 may control the power management integrated circuit 130 to supply the pixel power to each of the red, green and blue subpixels 121R, 121G and 121B included in the pixel 121.

In operation 405, the processor 150 may control the power management integrated circuit 130 to measure a current value (e.g., the second current value) flowing through the pixels 121 and 122. The measured current value may be transmitted from the power management integrated circuit 130 to the processor 150.

In operation 407, the processor 150 may, for example, subtract the current value (or the second current value) received from the power management integrated circuit 130 from the current value (or the first current value) stored in the memory 140, and may calculate the amount of deterioration of each of the pixels 121 and 122 (or the subpixels 121R, 121G, 121B, 122R, 122G and 122B) based on the subtraction result (e.g., difference). For example, the processor 150 may determine that the amount of deterioration of each of the subpixels 121R, 121G, 121B, 122R, 122G and 122B is larger as the difference between the first and second current values is larger, and may determine that the amount of deterioration of each of the subpixels 121R, 121G, 121B, 122R, 122G and 122B is smaller as the difference between the first and second current values is smaller. According to an embodiment, the amount of deterioration may be calculated as, for example, and without limitation, a magnitude of current (mA), a brightness (nit) of a pixel, a grayscale, or the like.

According to an embodiment of the present disclosure, the amount of deterioration caused in the display 120 may be accurately calculated by calculating the amount of deterioration based on the current value flowing through the pixel (or the subpixel).

FIG. 4B is a flowchart illustrating an example method of operation of an electronic device according to another embodiment.

Referring to FIG. 4B, in operation 451, the processor 150 may control the display to display specified contents. The specified contents may, for example, and without limitation, include various images, moving pictures, icons, and the like displayed through the display 120. The specified contents may be displayed through the display 120 in response to, for example, and without limitation, a user input, may be displayed through the display 120 at a specified time or by specified periods, or the like.

In operation 453, the processor 150 may control the electronic device to measure the second current value supplied to at least some of the pixels through the power management integrated circuit 130 while the specified contents are displayed. At least some of the pixels may refer, for example, to all pixels included in the display 120, or to pixels that display the specified contents. In another embodiment, at least some of the pixels may refer to pixels located in a partial area. For example, at least some of the pixels may refer to pixels arranged in an area through which a home key, a back key, a menu key, and the like are displayed.

In operation 455, the processor 150 may determine a level associated with deterioration of the at least some pixels based on the difference between the first current value stored in the memory 140 and the measured second current value. For example, when the difference value is large, the processor 150 may determine that the level associated with the deterioration of the at least some of the pixels is high, and when the difference value is small, the processor 150 may determine that the level associated with the deterioration of the at least some of the pixels is low.

As another embodiment, the processor 150 may determine a level associated with deterioration of the at least some of the pixels when the difference value is in a specified range. For example, when the difference value is in the range of 5 mA to 20 mA, the processor 150 may determine the level associated with deterioration of the at least some of the pixels.

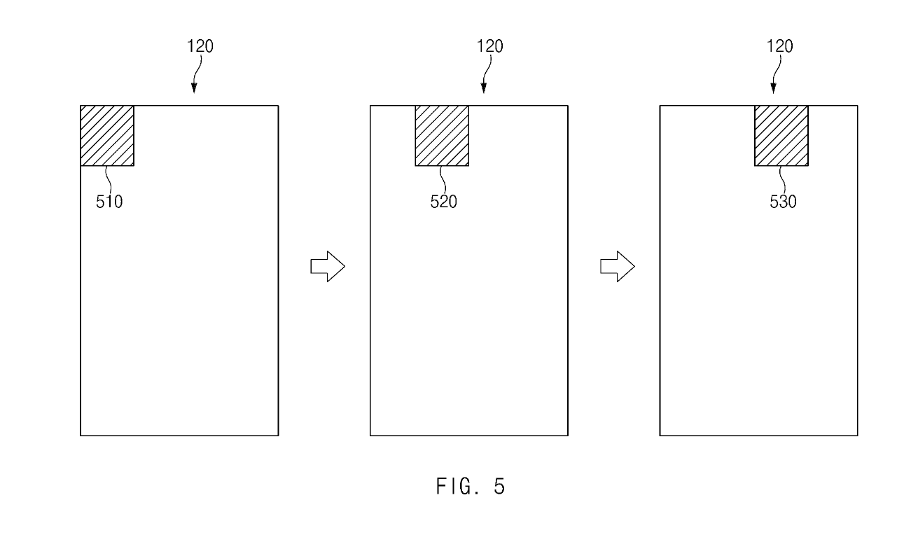

FIG. 5 is a diagram illustrating an example electronic device for calculating the amount of deterioration occurring in a partial area of a display according to an embodiment.

Referring to FIG. 5, the electronic device 100 may sequentially calculate the amount of deterioration occurring in a partial area of the display 120. For example, the electronic device 100 may calculate the amount of deterioration occurring in a first area 510 and calculate the amount of deterioration occurring in a second area 520. Then, the electronic device 100 may calculate the amount of deterioration occurring in a third area 530. Through the above-described process, the electronic device 100 may calculate the amount of deterioration occurring in the entire area of the display 120.

The embodiment illustrated in FIG. 5 is only an example, and various embodiments of the present disclosure may be different from that illustrated in FIG. 5. For example, the electronic device 100 may calculate the amount of deterioration occurring in the entire area of the display 120 at one time, and may calculate the amount of deterioration occurring in each pixel or each subpixel. As another example, the electronic device 100 may calculate the amount of deterioration in the order of the third area 530, the second area 520, and the first area 510.

According to an embodiment, the electronic device 100 may calculate the amount of deterioration of an area specified by a user. For example, when the user wants to know the amount of deterioration occurring in the first area 510, the user may specify the area in which the amount of deterioration is to be calculated by dragging the first area 510. The electronic device 100 may calculate the amount of deterioration occurring in the first area 510 based on the user input.

According to an embodiment, the electronic device 100 may reduce a deterioration measurement range when the current value difference in a specific area is large. For example, the electronic device 100 may measure the first and second current values in the first area 510 and calculate the difference between the first and second current values. When the difference is greater than or equal to a specified value, the electronic device 100 may reduce the size of the first area 510 and may recalculate the amount of deterioration in the first area reduced. According to an embodiment of the present disclosure, when the difference between the first and second current values is greater than or equal to the specified value, an accurate amount of deterioration may be obtained by recalculating the amount of deterioration.

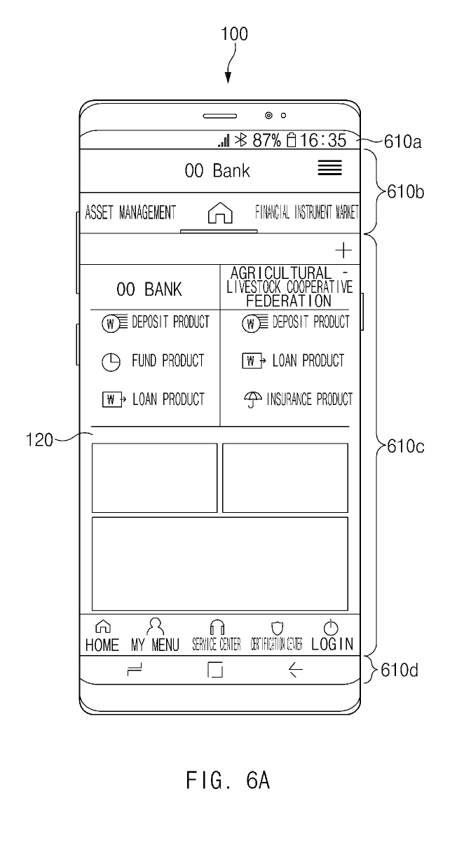

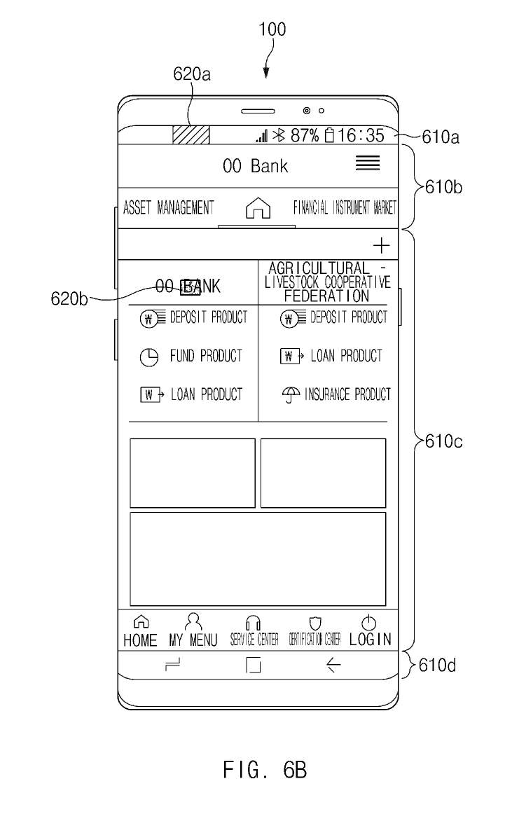

FIG. 6A is a diagram illustrating a display divided into several areas according to an embodiment. FIG. 6B is a diagram illustrating a state in which an electronic device according to an embodiment adjusts a deterioration amount calculation range. FIG. 6B illustrates an example state in which the electronic device 100 adjusts deterioration amount calculation ranges for several areas shown in FIG. 6A. In the present disclosure, the deterioration amount calculation range may refer, for example, to a range or an area where the electronic device 100 is capable of calculating the amount of deterioration.

Referring to FIG. 6A, the display 120 may be divided into a plurality of areas. For example, the display 120 may be divided into an a-area 610a, a b-area 610b, a c-area 610c, and a d-area 610d. The a-area 610a may refer, for example, to an area through which the battery remaining amount, the network status, whether or not the Bluetooth is connected, and the like are output. The b-area 610b may refer, for example, to an area through which a name of an app executed by the user and the like are outputted. For example, when the user executes a bank app, the bank name, menu, and the like may be output through the b-area 610b.

The c-area 610c may, for example, be an area in which the image output according to a user input is continuously changed. For example, according to an example embodiment, when a user views a transaction history, a bank statement image may be output through the c-area 610c. As another example, when the user transfers cash to a user's account, an image for inputting an account number and a password may be output through the c-area 610c. The d-area 610d may refer, for example, to an area through which a back key, a home key, a menu key, and the like are output.

When the a to d-areas 610a to 610d are compared with each other, an image of a pattern relatively constant in comparison with the b-area 610b and the c-area 610c may be output into the a-area 610a and the d-area 610d. Since an image of a constant pattern is continuously output to the a-area 610a and the d-area 610d, it may be relatively easy to predict the amount of deterioration as compared with the b-area 610b and the c-area 610c. However, since different images are output to the b-area 610b and the c-area 610c every time when the user's input is input, it may not be easy to predict the amount of deterioration as compared with the a-area 610a and the d-area 610d.

Referring to FIG. 6B, the electronic device 100 may adjust the deterioration amount calculation range according to whether it is an area where the deterioration amount is easy to predict. For example, since it is relatively easy to predict the amount of deterioration occurring in the a-area 610a, the electronic device 100 may set a wide deterioration amount calculation range 620a for the a-area 610a. Since the image of a constant pattern is continuously outputted into the a-area 610a and the predictability of the deterioration amount is high, the electronic device 100 may accurately calculate the amount of deterioration even if the wide deterioration amount calculation range 620a is set in the a-area 610a. In addition, the electronic device 100 may improve the deterioration amount calculating speed by setting the wide deterioration amount calculation range 620a in the a-area 610a.

On the other hand, since it is not easy to predict the amount of deterioration occurring in the c-area 610c, the electronic device 100 may set a narrow deterioration amount calculation range 620b in the c-area 610c. Since the image output in accordance with the user input continuously changes and the predictability of the deterioration amount is low in the c-area 610c, the electronic device 100 may set the narrow deterioration amount calculation range 620b to calculate the accurate amount of deterioration.

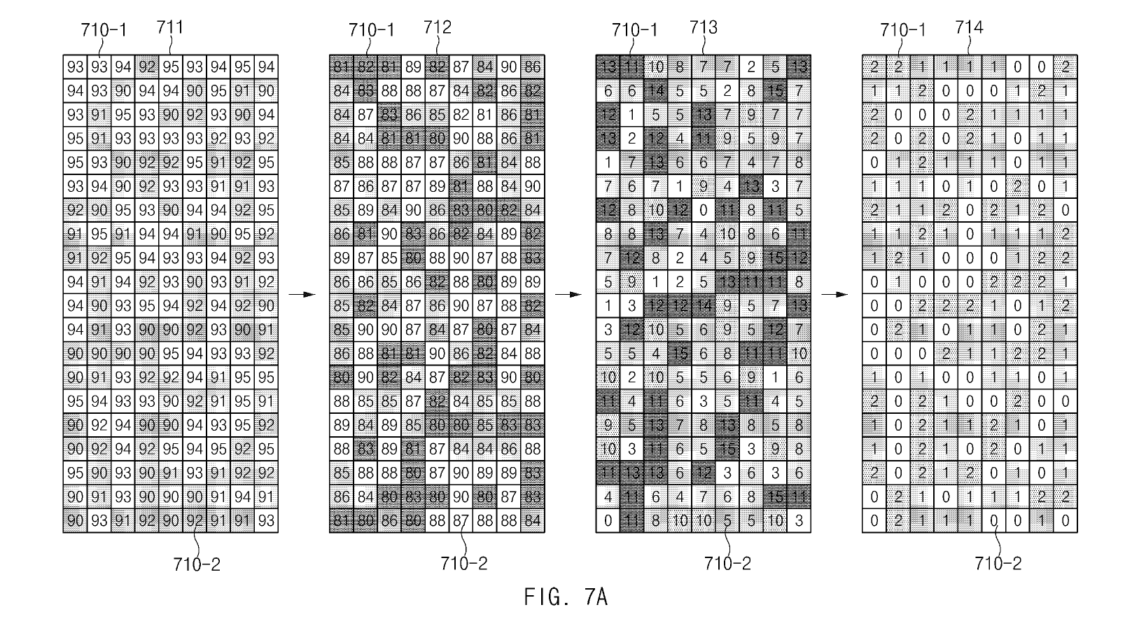

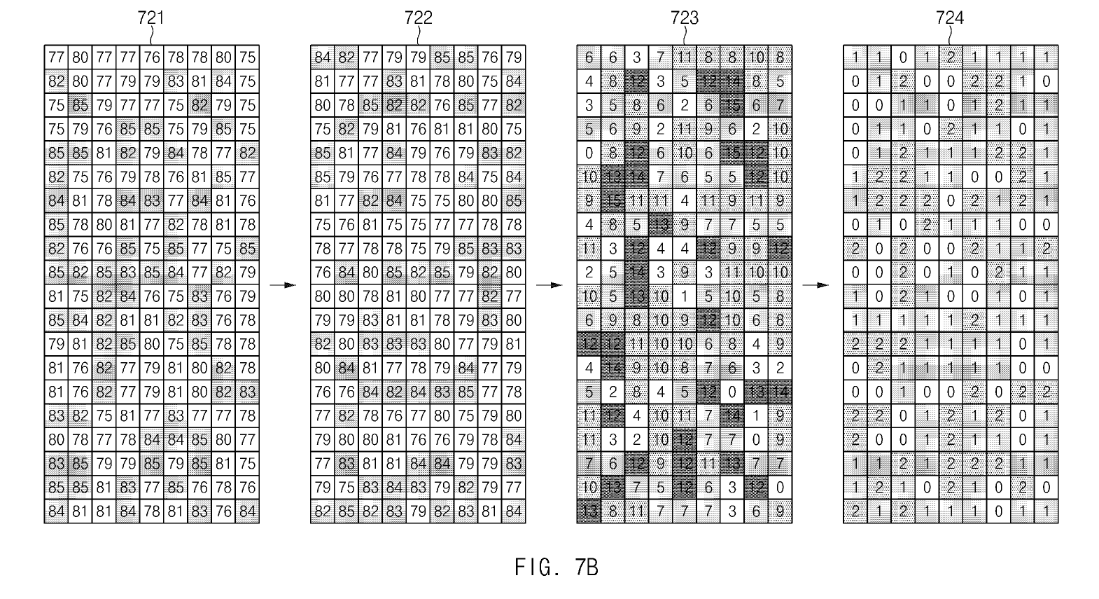

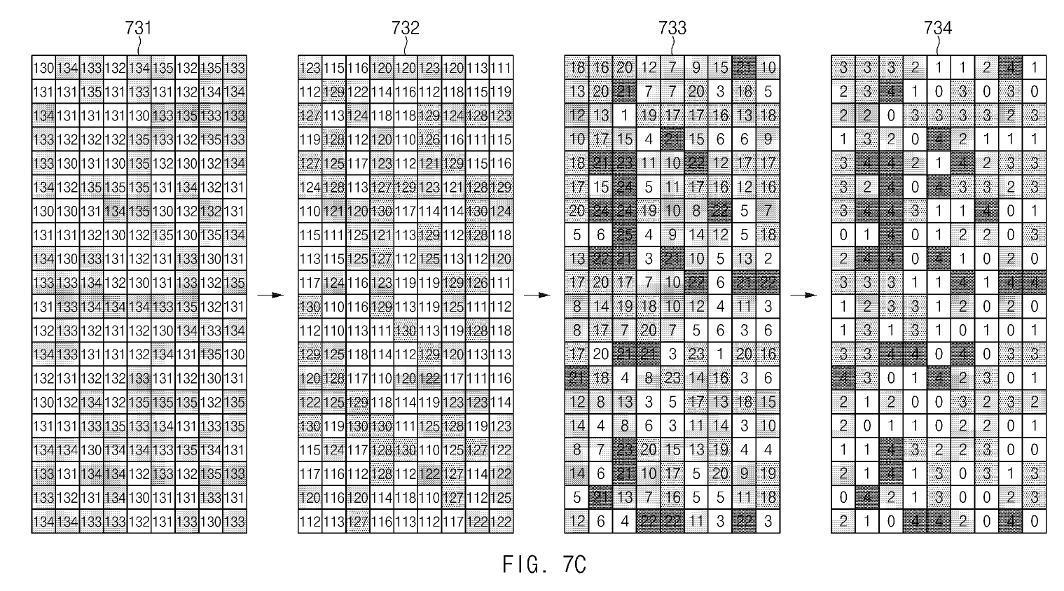

FIG. 7A is a diagram illustrating example current values flowing through red subpixels according to an embodiment. FIG. 7B is a diagram illustrating example current values flowing in green subpixels according to an embodiment. FIG. 7C is a diagram illustrating example current values flowing through blue subpixels according to an embodiment.

Referring to FIG. 7A, a plurality of red subpixels may be arranged line by line on the display 120. A first table 711 shows a first current value flowing through the red subpixels at a first time point. The first table 711 may be stored in the memory 140. A second table 712 shows a second current value flowing through the red subpixels at a second time point. The second table 712 may be values measured at the power management integrated circuit 130.

A third table 713 shows a delta value obtained by subtracting the second current value from the first current value. The third table 713 may be values calculated by the processor 150. The fourth table 714 shows the result of calculating a degree of deterioration of each of the red subpixels based on the delta value.

When the user input for calculating the amount of deterioration is received, the electronic device 100 may measure the current value flowing through each of the red subpixels. As the use time of the display 120 increases, deterioration of the red subpixels proceeds, so that the second current value may be smaller than the first current value. The measured value may be referred to, for example, as the value described in the second table 712.

When the second table 712 is obtained, the electronic device 100 may obtain the third table 713 by, for example, subtracting the second table 712 from the first table 711. For example, in case of a first red subpixel 710-1, since the first current value is 93 mA and the second current value is 82 mA, the delta value may be 11 mA. In case of a second red subpixel 710-2, since the first current value is 92 mA and the second current value is 87 mA, the delta value may be 5 mA. The electronic device 100 may perform the operations described above for each red subpixel arranged in the display 120, so that the third table 713 may be obtained.

When the third table 713 is obtained, the electronic device 100 may calculate the degree of deterioration of each of the red subpixels based on the third table 713. For example, since the delta value of the first red subpixel 710-1 is 11 mA, the electronic device 100 may determine that deterioration is progressed somewhat in the first red subpixel 710-1 (e.g., the degree of deterioration is in a second stage). On the other hand, in case of the second red subpixel 710-2, since the delta value is just 5 mA, the electronic device 100 may determine that the deterioration is hardly progressed in the second red subpixel 710-2 (e.g., the degree of deterioration is zero). The electronic device 100 may perform the operations described above for each red subpixel arranged in the display 120 and thus obtain the fourth table 714.

According to another embodiment, the operations of the electronic device 100 illustrated in FIG. 7A may also be applied to FIG. 7B. For example, the electronic device 100 may subtract a second current value 722 from a first current value 721 flowing through the green subpixels, and may calculate a degree of deterioration 724 based on a subtraction result 723. However, the current value flowing through the green subpixels may be somewhat smaller than the current value flowing through the red subpixels, so that the degree of deterioration may be calculated differently from the red subpixels. For example, the amount of deterioration occurring in the green subpixels may be smaller than that of the red subpixels.

According to still another embodiment, the operations of the electronic device 100 described in FIG. 7A may also be applied to FIG. 7C. For example, the electronic device 100 may subtract a second current value 732 from a first current value 731 flowing through the blue subpixels and may calculate a degree 734 of deterioration of each of the blue subpixels based on a subtraction result 733. However, the current value flowing through the blue subpixels may be somewhat larger than the current value flowing through the red subpixels, so that the degree of deterioration may be calculated differently from the red subpixels. For example, the amount of deterioration occurring in the blue subpixels may be larger than that of the red subpixels.

An electronic device according to an example embodiment may include a display including at least one pixel, a memory that stores a first current value flowing through the pixel at a first time point, a power management integrated circuit (PMIC) that supplies pixel power to the pixel, and a processor operatively connected to the memory and the PMIC, wherein the processor may be configured to control the PMIC to supply the pixel power to the pixel in response to a user input for calculating an amount of deterioration of the pixel, receive a second current value flowing through the pixel at a second time point from the PMIC, and calculate the amount of deterioration of the pixel based on the first current value and the second current value.

According to an example embodiment, the first time point may correspond to a time point before the deterioration of the pixel occurs.

According to an example embodiment, the second time point may correspond to a time point after the deterioration of the pixel occurs.

According to an example embodiment, the pixel may include an organic light emitting diode (OLED), and each of the first and second current values may correspond to a magnitude of a current flowing through the OLED.

According to an example embodiment, the memory may correspond to a non-volatile memory included in the processor.

According to an example embodiment, the memory may store an application for calculating the amount of deterioration of the pixel, and the processor may calculate the amount of deterioration of the pixel in response to a user input for executing the application.

According to an example embodiment, the processor may calculate the amount of deterioration of the pixel at a specified time point or by specified periods.

According to an example embodiment, the at least one pixel may include a first group of pixels arranged in a first area of the display and a second group of pixels arranged in a second area of the display.

According to an example embodiment, the processor may calculate an amount of deterioration of the first group of pixels and an amount of deterioration of the second group of pixels.

According to an example embodiment, a size of the first area may be different from a size of the second area.

According to an example embodiment, the first area may correspond to an area in the display where a specified image is displayed.

According to an example embodiment, the processor may reduce brightness of the pixel when a difference between the first and second current values is greater than or equal to a specified value.

According to an example embodiment, each of the at least one pixel may include a plurality of subpixels, and the processor may calculate an amount of deterioration of each of the subpixels.

An electronic device according to an embodiment may include a display including at least one pixel, a power management integrated circuit connected to the pixel, a memory that stores an initial current value flowing through the pixel, and a processor operatively connected to the power management integrated circuit and the memory, wherein the processor may control the power management integrated circuit to supply a current to the pixel in response to a user input for calculating an amount of deterioration of the pixel, and calculate the amount of deterioration of the pixel based on a difference between a current value flowing the pixel and the initial current value.

According to an example embodiment, the processor may allow the power management integrated circuit to measure the initial current value.

According to an example embodiment, the processor may reduce brightness of the pixel when a difference between the current value flowing through the pixel and the initial current value is equal to or higher than a specified level.

According to an example embodiment, each of the at least one pixel may include a red subpixel, a green subpixel, and a blue subpixel, and the processor may calculate an amount of deterioration of each of the red subpixel, the green subpixel, and the blue subpixel.

According to an example embodiment, the electronic device may further include a printed circuit board (PCB) arranged within the electronic device, and the power management integrated circuit, the memory, and the processor may be disposed on the printed circuit board.

According to an example embodiment, the electronic device may further include a battery disposed within the electronic device, and the power management integrated circuit may receive electric energy from the battery and supply the current to the pixel.

According to an example embodiment, the processor may correspond to an application processor, and the memory may correspond to a non-volatile memory included in the application processor.

A method of calculating an amount of deterioration according to an example embodiment may include supplying (e.g., by the power management integrated circuit) pixel power to a pixel in response to a user input for calculating an amount of deterioration of the pixel, measuring (e.g., by the power management integrated circuit) a current value flowing through the pixel when a current flows through the pixel, receiving the measured current value from the power management integrated circuit, and calculating the amount of deterioration of the pixel based on a difference between the measured current value and a current value stored in a memory.

An electronic device according to an embodiment may include a display including one or more pixels, a power supply circuit that supplies power to the one or more pixels, a memory that stores a first current value supplied to at least some pixels of the one or more pixels through the power supply circuit, and a processor, wherein the processor may control the display to display specified contents, measure a second current value supplied to the at least some pixels through the power supply circuit while the specified contents are displayed, and determine a level associated with deterioration of the at least some pixels based at least on a difference between the first current value and the second current value.

According to an example embodiment, the processor may determine the level associated with deterioration of the at least some pixels when the difference value is in a specified range.

According to an example embodiment, the display may include a display driver integrated circuit (DDI) and the memory may be included in the DDI.

An electronic device according to an example embodiment may include a display including one or more pixels, a power supply circuit that supplies power to the one or more pixels, and a processor, wherein the processor may control the display to display specified contents, measure a first current value supplied to at least some pixels through the power supply circuit while the specified contents are displayed, and based on at least a difference between the first current value and a second current value measured through the power supply circuit before measuring the first current value, determine a level associated with deterioration of the at least some pixels based at least on a difference between the first current value and a second current value measured through the power supply circuit before measuring the first current value.

According to an example embodiment, when the difference between the first and second current values is in the specified range, the processor may determine the level associated with deterioration of the at least some pixels.

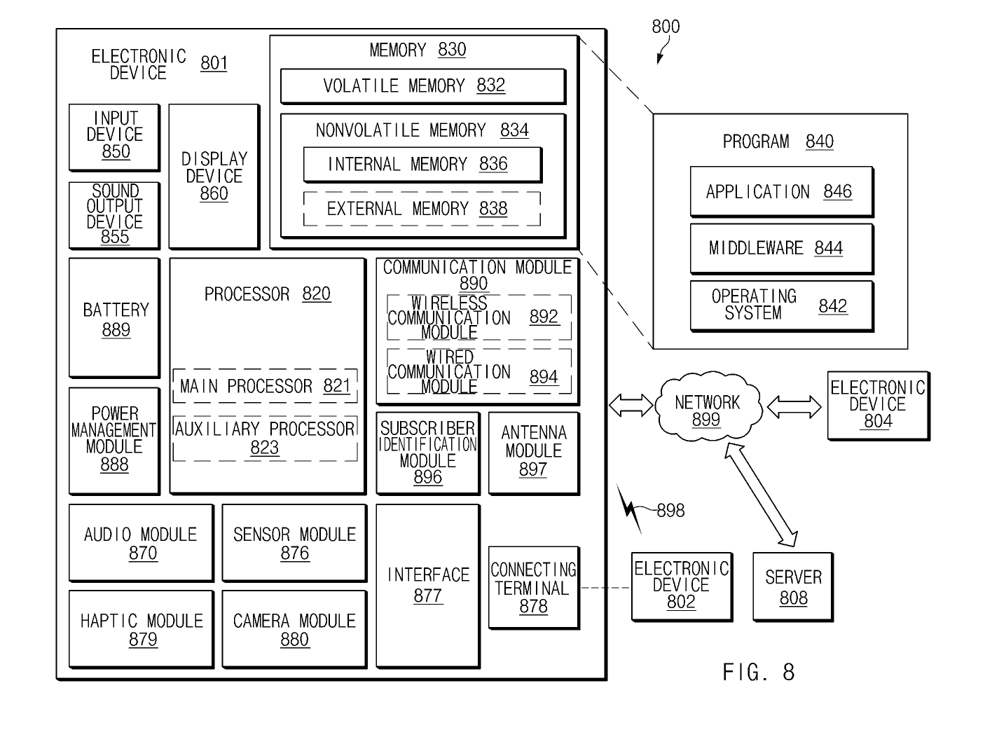

FIG. 8 is a block diagram illustrating an example electronic device in a network environment according to various embodiments.

Referring to FIG. 8, an electronic device 801 may communicate with an electronic device 802 through a first network 898 (e.g., a short-range wireless communication) or may communicate with an electronic device 804 or a server 808 through a second network 899 (e.g., a long-distance wireless communication) in a network environment 800. According to an embodiment, the electronic device 801 may communicate with the electronic device 804 through the server 808. According to an embodiment, the electronic device 801 may include a processor 820, a memory 830, an input device 850, a sound output device 855, a display device 860, an audio module 870, a sensor module 876, an interface 877, a haptic module 879, a camera module 880, a power management module 888, a battery 889, a communication module 890, a subscriber identification module 896, and an antenna module 897. According to some embodiments, at least one (e.g., the display device 860 or the camera module 880) among components of the electronic device 801 may be omitted or other components may be added to the electronic device 801. According to some embodiments, some components may be integrated and implemented as in the case of the sensor module 876 (e.g., a fingerprint sensor, an iris sensor, or an illuminance sensor) embedded in the display device 860 (e.g., a display).

The processor 820 may operate, for example, software (e.g., a program 840) to control at least one of other components (e.g., a hardware or software component) of the electronic device 801 connected to the processor 820 and may process and compute a variety of data. The processor 820 may load a command set or data, which is received from other components (e.g., the sensor module 876 or the communication module 890), into a volatile memory 832, may process the loaded command or data, and may store result data into a nonvolatile memory 834. According to an embodiment, the processor 820 may include a main processor 821 (e.g., a central processing unit or an application processor) and an auxiliary processor 823 (e.g., a graphic processing device, an image signal processor, a sensor hub processor, or a communication processor), which operates independently from the main processor 821, additionally or alternatively uses less power than the main processor 821, or is specified to a designated function. In this case, the auxiliary processor 823 may operate separately from the main processor 821 or embedded.

In this case, the auxiliary processor 823 may control, for example, at least some of functions or states associated with at least one component (e.g., the display device 860, the sensor module 876, or the communication module 890) among the components of the electronic device 801 instead of the main processor 821 while the main processor 821 is in an inactive (e.g., sleep) state or together with the main processor 821 while the main processor 821 is in an active (e.g., an application execution) state. According to an embodiment, the auxiliary processor 823 (e.g., the image signal processor or the communication processor) may be implemented as a part of another component (e.g., the camera module 880 or the communication module 890) that is functionally related to the auxiliary processor 823. The memory 830 may store a variety of data used by at least one component (e.g., the processor 820 or the sensor module 876) of the electronic device 801, for example, software (e.g., the program 840) and input data or output data with respect to commands associated with the software. The memory 830 may include the volatile memory 832 or the nonvolatile memory 834.

The program 840 may be stored in the memory 830 as software and may include, for example, an operating system 842, a middleware 844, or an application 846.

The input device 850 may be a device for receiving a command or data, which is used for a component (e.g., the processor 820) of the electronic device 801, from an outside (e.g., a user) of the electronic device 801 and may include, for example, a microphone, a mouse, or a keyboard.

The sound output device 855 may be a device for outputting a sound signal to the outside of the electronic device 801 and may include, for example, a speaker used for general purposes, such as multimedia play or recordings play, and a receiver used only for receiving calls. According to an embodiment, the receiver and the speaker may be either integrally or separately implemented.

The display device 860 may be a device for visually presenting information to the user of the electronic device 801 and may include, for example, a display, a hologram device, or a projector and a control circuit for controlling a corresponding device. According to an embodiment, the display device 860 may include a touch circuitry or a pressure sensor for measuring an intensity of pressure on the touch.

The audio module 870 may convert a sound and an electrical signal in dual directions. According to an embodiment, the audio module 870 may obtain the sound through the input device 850 or may output the sound through an external electronic device (e.g., the electronic device 802 (e.g., a speaker or a headphone)) wired or wirelessly connected to the sound output device 855 or the electronic device 801.

The sensor module 876 may generate an electrical signal or a data value corresponding to an operating state (e.g., power or temperature) inside or an environmental state outside the electronic device 801. The sensor module 876 may include, for example, a gesture sensor, a gyro sensor, a barometric pressure sensor, a magnetic sensor, an acceleration sensor, a grip sensor, a proximity sensor, a color sensor, an infrared sensor, a biometric sensor, a temperature sensor, a humidity sensor, or an illuminance sensor.

The interface 877 may support a designated protocol wired or wirelessly connected to the external electronic device (e.g., the electronic device 802). According to an embodiment, the interface 877 may include, for example, an HDMI (high-definition multimedia interface), a USB (universal serial bus) interface, an SD card interface, or an audio interface.

A connecting terminal 878 may include a connector that physically connects the electronic device 801 to the external electronic device (e.g., the electronic device 802), for example, an HDMI connector, a USB connector, an SD card connector, or an audio connector (e.g., a headphone connector).

The haptic module 879 may convert an electrical signal to a mechanical stimulation (e.g., vibration or movement) or an electrical stimulation perceived by the user through tactile or kinesthetic sensations. The haptic module 879 may include, for example, a motor, a piezoelectric element, or an electric stimulator.

The camera module 880 may shoot a still image or a video image. According to an embodiment, the camera module 880 may include, for example, at least one lens, an image sensor, an image signal processor, or a flash.

The power management module 888 may be a module for managing power supplied to the electronic device 801 and may serve as at least a part of a power management integrated circuit (PMIC).

The battery 889 may be a device for supplying power to at least one component of the electronic device 801 and may include, for example, a non-rechargeable (primary) battery, a rechargeable (secondary) battery, or a fuel cell.

The communication module 890 may establish a wired or wireless communication channel between the electronic device 801 and the external electronic device (e.g., the electronic device 802, the electronic device 804, or the server 808) and support communication execution through the established communication channel. The communication module 890 may include at least one communication processor operating independently from the processor 820 (e.g., the application processor) and supporting the wired communication or the wireless communication. According to an embodiment, the communication module 890 may include a wireless communication module 892 (e.g., a cellular communication module, a short-range wireless communication module, or a GNSS (global navigation satellite system) communication module) or a wired communication module 894 (e.g., an LAN (local area network) communication module or a power line communication module) and may communicate with the external electronic device using a corresponding communication module among them through the first network 898 (e.g., the short-range communication network such as a Bluetooth, a WiFi direct, or an IrDA (infrared data association)) or the second network 899 (e.g., the long-distance wireless communication network such as a cellular network, an internet, or a computer network (e.g., LAN or WAN)). The above-mentioned various communication modules 890 may be implemented into one chip or into separate chips, respectively.

According to an embodiment, the wireless communication module 892 may identify and authenticate the electronic device 801 using user information stored in the subscriber identification module 896 in the communication network.

The antenna module 897 may include one or more antennas to transmit or receive the signal or power to or from an external source. According to an embodiment, the communication module 890 (e.g., the wireless communication module 892) may transmit or receive the signal to or from the external electronic device through the antenna suitable for the communication method.

Some components among the components may be connected to each other through a communication method (e.g., a bus, a GPIO (general purpose input/output), an SPI (serial peripheral interface), or an MIPI (mobile industry processor interface)) used between peripheral devices to exchange signals (e.g., a command or data) with each other.

According to an embodiment, the command or data may be transmitted or received between the electronic device 801 and the external electronic device 804 through the server 808 connected to the second network 899. Each of the electronic devices 802 and 804 may be the same or different types as or from the electronic device 801. According to an embodiment, all or some of the operations performed by the electronic device 801 may be performed by another electronic device or a plurality of external electronic devices. When the electronic device 801 performs some functions or services automatically or by request, the electronic device 801 may request the external electronic device to perform at least some of the functions related to the functions or services, in addition to or instead of performing the functions or services by itself. The external electronic device receiving the request may carry out the requested function or the additional function and transmit the result to the electronic device 801. The electronic device 801 may provide the requested functions or services based on the received result as is or after additionally processing the received result. To this end, for example, a cloud computing, distributed computing, or client-server computing technology may be used.

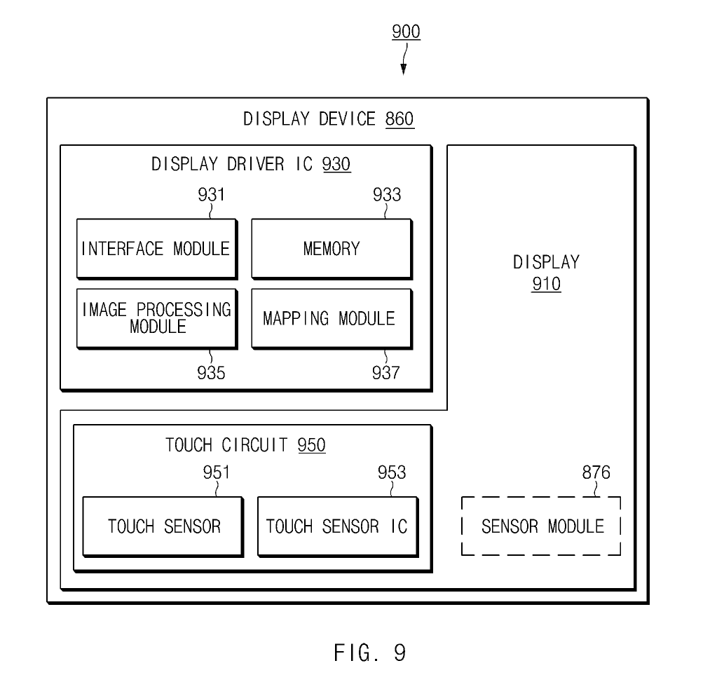

FIG. 9 is a block diagram illustrating an example display device according to various embodiments.

Referring to FIG. 9, the display device 860 may include a display 910 and a display driver IC (DDI) 930 for controlling the display 910. The DDI 930 may include an interface module 931, a memory 933 (e.g., a buffer memory), an image processing module 935, or a mapping module 937. For example, the DDI 930 may receive image information including image data or an image control signal corresponding to a command for controlling the image data from a processor 820 (e.g., a main processor 821 or an application processor) or an auxiliary processor 823, which is operated independently of the main processor 821, through the interface module 931. The DDI 930 may communicate with a touch circuit 950, the sensor module 876, or the like through the interface module 931. In addition, the DDI 930 may store at least a part of the received image information in the memory 933, for example, in units of frames. For example, the image processing module 935 may perform preprocessing or post-processing (e.g., adjustment of resolution, brightness, or size) on at least a part of the image data based at least partially on characteristics of the image data or the display 910. The mapping module 937 may convert the image data preprocessed or post-processed through the image processing module 935 into a voltage value or a current value capable of driving the pixels, based at least partially on attributes of the pixels of the display 910 (e.g., an array of pixels (RGB stripe or pentile) or a size of each of subpixels). For example, at least some pixels of the display 910 may be driven based on the voltage or current value, such that visual information (e.g., a text, an image, or an icon) corresponding to the image data is displayed on the display 910.

According to an embodiment, the display device 860 may further include the touch circuit 950. The touch circuit 950 may include a touch sensor 951 and a touch sensor IC 953 for controlling the touch sensor 951. The touch sensor IC 953 may controls the touch sensor 951 to measure, for example, a change in a signal (e.g., a voltage, a light amount, a resistance, or a charge amount) at a specific position of the display 910 to sense a touch input or a hovering input, and may provide information (e.g., a location, an area, a pressure or a time) about the sensed touch input or hovering input to the processor 820. According to an embodiment, at least a part (e.g., the touch sensor IC 953) of the touch circuit 950 may be included as a part of the display driver IC 930 or the display 910, or as a part of another component (e.g., the auxiliary processor 823) arranged outside the display device 860.

According to an embodiment, the display device 860 may further include at least one sensor (e.g., a fingerprint sensor, an iris sensor, a pressure sensor or an illuminance sensor) of the sensor module 876, or a control circuitry thereof. In this case, the at least one sensor or the control circuitry thereof may be embodied in a part (e.g., the display 910 or the DDI 930) of the display device 860 or a part of the touch circuit 950. For example, when the sensor module 876 embedded in the display device 860 includes a biometric sensor (e.g., a fingerprint sensor), the biometric sensor may obtain biometric information associated with a touch input through an area of the display 910. As another example, when the sensor module 876 embedded in the display device 860 includes a pressure sensor, the pressure sensor may obtain information about a pressure corresponding to a touch input through an area or entire area of the display 910. According to an embodiment, the touch sensor 951 or the sensor module 876 may be arranged between pixels of the pixel layer of the display 910, or above or below the pixel layer.

The electronic device according to various embodiments disclosed in the present disclosure may be various types of devices. The electronic device may include, for example, at least one of a portable communication device (e.g., a smartphone), a computer device, a portable multimedia device, a mobile medical appliance, a camera, a wearable device, or a home appliance. The electronic device according to an embodiment of the present disclosure should not be limited to the above-mentioned devices.

It should be understood that various embodiments of the present disclosure and terms used in the embodiments do not intend to limit technologies disclosed in the present disclosure to the particular forms disclosed herein; rather, the present disclosure should be construed to cover various modifications, equivalents, and/or alternatives of embodiments of the present disclosure. With regard to description of drawings, similar components may be assigned with similar reference numerals. As used herein, singular forms may include plural forms as well unless the context clearly indicates otherwise. In the present disclosure disclosed herein, the expressions “A or B”, “at least one of A or/and B”, “A, B, or C” or “one or more of A, B, or/and C”, and the like used herein may include any and all combinations of one or more of the associated listed items. The expressions “a first”, “a second”, “the first”, or “the second”, used in herein, may refer to various components regardless of the order and/or the importance, but do not limit the corresponding components. The above expressions are used merely for the purpose of distinguishing a component from the other components. It should be understood that when a component (e.g., a first component) is referred to as being (operatively or communicatively) “connected,” or “coupled,” to another component (e.g., a second component), it may be directly connected or coupled directly to the other component or any other component (e.g., a third component) may be interposed between them.

The term “module” used herein may represent, for example, a unit including one or more combinations of hardware, software and firmware. The term “module” may be interchangeably used with the terms “logic”, “logical block”, “part” and “circuit”. The “module” may be a minimum unit of an integrated part or may be a part thereof. The “module” may be a minimum unit for performing one or more functions or a part thereof. For example, the “module” may include an application-specific integrated circuit (ASIC).

Various embodiments of the present disclosure may be implemented by software (e.g., the program 840) including an instruction stored in a machine-readable storage media (e.g., an internal memory 836 or an external memory 838) readable by a machine (e.g., a computer). The machine may be a device that calls the instruction from the machine-readable storage media and operates depending on the called instruction and may include the electronic device (e.g., the electronic device 801). When the instruction is executed by the processor (e.g., the processor 820), the processor may perform a function corresponding to the instruction directly or using other components under the control of the processor. The instruction may include a code generated or executed by a compiler or an interpreter. The machine-readable storage media may be provided in the form of non-transitory storage media. Here, the term “non-transitory”, as used herein, is a limitation of the medium itself (i.e., tangible, not a signal) as opposed to a limitation on data storage persistency.

According to an embodiment, the method according to various embodiments disclosed in the present disclosure may be provided as a part of a computer program product. The computer program product may be traded between a seller and a buyer as a product. The computer program product may be distributed in the form of machine-readable storage medium (e.g., a compact disc read only memory (CD-ROM)) or may be distributed only through an application store (e.g., a Play Store™). In the case of online distribution, at least a portion of the computer program product may be temporarily stored or generated in a storage medium such as a memory of a manufacturer's server, an application store's server, or a relay server.

Each component (e.g., the module or the program) according to various embodiments may include at least one of the above components, and a portion of the above sub-components may be omitted, or additional other sub-components may be further included. Alternatively or additionally, some components (e.g., the module or the program) may be integrated in one component and may perform the same or similar functions performed by each corresponding components prior to the integration. Operations performed by a module, a programming, or other components according to various embodiments of the present disclosure may be executed sequentially, in parallel, repeatedly, or in a heuristic method. Also, at least some operations may be executed in different sequences, omitted, or other operations may be added.

While the present disclosure has been illustrated and described with reference to various example embodiments thereof, it will be understood by those skilled in the art that various changes in form and details may be made therein without departing from the spirit and scope of the present disclosure as defined, for example, by the appended claims and their equivalents.

What is claimed is:

1. An electronic device comprising:
a display including at least one pixel;
a memory configured to store a first current value flowing through the pixel at a first time point;
a power management integrated circuit (PMIC) configured to supply pixel power to the pixel; and
a processor operatively connected to the memory and the PMIC,
wherein the processor is configured to:
supply the pixel power to the pixel through the PMIC in response to a user input for calculating an amount of deterioration of the pixel;
receive a second current value flowing through the pixel at a second time point from the PMIC; and
calculate the amount of deterioration of the pixel based on the first current value and the second current value.

2. The electronic device of claim 1, wherein the first time point corresponds to a time point before the deterioration of the pixel occurs.

3. The electronic device of claim 1, wherein the second time point corresponds to a time point after the deterioration of the pixel occurs.

4. The electronic device of claim 1, wherein the pixel comprises an organic light emitting diode (OLED), and
wherein each of the first and second current values corresponds to a magnitude of a current flowing through the OLED.

5. The electronic device of claim 1, wherein the memory comprises a non-volatile memory included in the processor.

6. The electronic device of claim 1, wherein the memory is configured to store an application for calculating the amount of deterioration of the pixel, and
wherein the processor is configured to calculate the amount of deterioration of the pixel in response to a user input for executing the application.

7. The electronic device of claim 1, wherein the processor is configured to calculate the amount of deterioration of the pixel at a specified time point and/or by specified periods.

8. The electronic device of claim 1, wherein the at least one pixel includes a first group of pixels arranged in a first area of the display and a second group of pixels arranged in a second area of the display.

9. The electronic device of claim 8, wherein the processor is configured to calculate an amount of deterioration of the first group of pixels and an amount of deterioration of the second group of pixels.

10. The electronic device of claim 8, wherein a size of the first area is different from a size of the second area.

11. The electronic device of claim 8, wherein the first area includes an area in the display where a specified image is displayed.

12. The electronic device of claim 1, wherein the processor is configured to reduce a brightness of the pixel when a difference between the first current value and second current value is greater than or equal to a specified value.

13. The electronic device of claim 1, wherein each of the at least one pixel includes a plurality of subpixels, and
wherein the processor is configured to calculate an amount of deterioration of each of the subpixels.

14. An electronic device comprising:
a display including at least one pixel;
a power management integrated circuit connected to the pixel;
a memory configured to store an initial current value flowing through the pixel; and
a processor operatively connected to the power management integrated circuit and the memory,
wherein the processor is configured to:
supply a current to the pixel through the power management integrated circuit in response to a user input for calculating an amount of deterioration of the pixel; and
calculate the amount of deterioration of the pixel based on a difference between a current value flowing the pixel and the initial current value.

15. The electronic device of claim 14, wherein the processor is configured to control the power management integrated circuit to measure the initial current value.

16. The electronic device of claim 14, wherein the processor is configured to reduce a brightness of the pixel when a difference between the current value flowing through the pixel and the initial current value is equal to or greater than a specified level.

17. The electronic device of claim 14, wherein each of the at least one pixel includes a red subpixel, a green subpixel, and a blue subpixel, and
wherein the processor is configured to calculate an amount of deterioration of each of the red subpixel, the green subpixel, and the blue subpixel.

18. The electronic device of claim 14, further comprising a printed circuit board (PCB) disposed within the electronic device,
wherein the power management integrated circuit, the memory, and the processor are disposed on the printed circuit board.

19. The electronic device of claim 14, further comprising a battery disposed within the electronic device,
wherein the power management integrated circuit is configured to receive electrical energy from the battery and to supply the current to the pixel.

20. The electronic device of claim 14, wherein the processor comprises an application processor, and
wherein the memory comprises a non-volatile memory included in the application processor.
